(19) United States
(12) Patent Application Publication
(10) Pub. No.: US 2026/0361031 A1
(43) Pub. Date: Nov. 12, 2026

(54) CONNECTOR DEVICE AND CONNECTOR SYSTEM

(71) Applicant: Chicony Power Technology Co., Ltd., New Taipei City (TW)

(72) Inventor: Po-Sheng LEE, New Taipei City (TW)

(21) Appl. No.: 19/332,027

(22) Filed: Sep. 17, 2025

(30) Foreign Application Priority Data
May 7, 2025 (TW) 114117207

(51) Int. Cl. H01R 13/631; H01R 13/24; H01R 13/66

(52) U.S. Cl. CPC H01R 13/631; H01R 13/24; H01R 13/665

(57) ABSTRACT

A connector device includes a housing, an electrical connector, a latch, and a control element. The housing is provided with a connection hole. The electrical connector is disposed in at least a part of the connection hole. The latch and the control element are movably disposed on the housing. The control element is configured to move the latch to a first position or a second position. When the latch is at the first position, a part of the latch is located in the connection hole. When the latch is at the second position, the part of the latch is located outside the connection hole.

### RELATED APPLICATIONS

The present application claims priority to Taiwan Application Serial Number 114117207, filed May 7, 2025, the disclosure of which is incorporated herein by reference in its entirety.

### BACKGROUND

### Technical Field

The present disclosure relates to a connector device and a connector system.

### Description of Related Art

A current power supply typically has a female connector, and a current electronic device is typically electrically connected to a male connector. When the male connector is combined with the female connector, the power supply provides power to the electronic device. If the male connector and the female connector are separated when the power supply provides high-voltage power, a voltage difference between the male connector and the female connector may easily cause arcing, which may damage the male connector and the female connector.

### SUMMARY

In order to solve the aforementioned technical problem, the present disclosure provides a connector device, which includes a housing, an electrical connector, a latch, and a control element. The housing is provided with a connection hole. The electrical connector is disposed in at least a part of the connection hole. The latch and the control element are movably disposed on the housing. The control element is configured to move the latch to a first position or a second position. When the latch is at the first position, a part of the latch is located in the connection hole. When the latch is at the second position, the part of the latch is located outside the connection hole.

In one or more embodiments of the present disclosure, the housing is further provided with a recess and a through hole. The through hole communicates with the recess and the connection hole. The control element is movably disposed in the recess. When the control element moves the latch to the first position, the part of the latch enters the connection hole through the through hole. When the control element moves the latch to the second position, the part of the latch exits the connection hole.

In one or more embodiments of the present disclosure, the latch is disposed on a surface of the control element close to the through hole, and a moving direction of the control element is substantially parallel to the through hole.

In one or more embodiments of the present disclosure, the moving direction of the control element is substantially perpendicular to the electrical connector.

In one or more embodiments of the present disclosure, the latch is movably disposed in the through hole, and the control element is rotatably disposed in the recess and contacts the latch.

In one or more embodiments of the present disclosure, the electrical connector is provided with a notch corresponding to a part of the through hole of the housing, or a via hole corresponding to an entirety of the through hole of the housing.

In one or more embodiments of the present disclosure, the latch is made of a conductive material.

In one or more embodiments of the present disclosure, the latch includes a body made of a non-conductive material and a conductive portion disposed on a surface of the body close to the connection hole.

According to some embodiments of the present disclosure, a connector system includes a first electrical connector and a connector device. The first electrical connector includes a first connection portion. The first connection portion includes a first shell and a plurality of first terminals disposed in the first shell. The connector device includes a housing, a second electrical connector, a latch, and a control element. The housing is provided with a connection hole. The second electrical connector includes a second connection portion. The second connection portion is disposed in at least a part of the connection hole and includes a second shell and a plurality of second terminals disposed in the second shell. The first terminals contact the second terminals when the first connection portion is combined with the second connection portion. The latch is movably disposed on the housing. The control element is configured to move the latch to a first position or a second position. When the latch is at the first position, a part of the latch is located in the connection hole and short-circuits at least two of the first terminals. When the latch is at the second position, the part of the latch is located outside the connection hole.

In one or more embodiments of the present disclosure, the housing is further provided with a recess and a through hole. The through hole communicates with the recess and the connection hole. The control element is movably disposed in the recess. When the control element moves the latch to the first position, the part of the latch enters the connection hole through the through hole. When the control element moves the latch to the second position, the part of the latch exits the connection hole.

In one or more embodiments of the present disclosure, the latch is disposed on a surface of the control element close to the through hole, and a moving direction of the control element is substantially parallel to the through hole.

In one or more embodiments of the present disclosure, the latch is movably disposed in the through hole, and the control element is rotatably disposed in the recess and contacts the latch.

In one or more embodiments of the present disclosure, the second electrical connector is provided with a notch corresponding to a part of the through hole of the housing, or a via hole corresponding to an entirety of the through hole of the housing.

In one or more embodiments of the present disclosure, the connector system further includes a controller chip. The control chip is disposed in the first electrical connector and is electrically connected to the at least two of the first terminals, or is disposed in the second electrical connector and is electrically connected to the second terminals corresponding to the at least two of the first terminals. The control chip is configured to detect whether the at least two of the first terminals are short-circuited, and to execute an action when the control chip detects that the at least two of the first terminals are short-circuited.

In one or more embodiments of the present disclosure, the first shell is provided with an opening. The opening exposes the at least two of the first terminals. The latch is made of a conductive material. When the latch is at the first position, the latch contacts the at least two of the first terminals.

In one or more embodiments of the present disclosure, the first shell is provided with an opening. The opening exposes the at least two of the first terminals. The latch includes a body made of a non-conductive material and a conductive portion disposed on a surface of the body close to the connection hole. When the latch is at the first position, the conductive portion contacts the at least two of the first terminals.

In one or more embodiments of the present disclosure, the first shell is made of a conductive material and includes a spring sheet corresponding to the at least two of the first terminals. The latch corresponds to the spring sheet. When the latch is at the first position, the latch makes the spring sheet contact the at least two of the first terminals.

### BRIEF DESCRIPTION OF THE DRAWINGS

FIG. 1 is a schematic diagram of a connector system according to an embodiment of the present disclosure.

FIG. 2 is an exploded view of a connector device in FIG. 1.

FIGS. 3 and 4 are cross-sectional views of the connector system in FIG. 1 in different states.

FIG. 5 is a cross-sectional view of a connector device according to another embodiment of the present disclosure.

FIG. 6 is a cross-sectional view of a connector system including the connector device in FIG. 5 according to another embodiment of the present disclosure.

FIG. 7 is a schematic diagram of an application of a connector system according to an embodiment of the present disclosure.

FIG. 8 is a schematic diagram of an application of a connector system according to another embodiment of the present disclosure.

FIG. 9 is a partially enlarged view of a first electrical connector according to another embodiment of the present disclosure.

FIGS. 10 and 11 are cross-sectional views of a connector system in different states according to another embodiment of the present disclosure.

### DETAILED DESCRIPTION

The embodiments of the present invention will be described clearly and completely below with reference to the accompanying drawings. The elements in the drawings are not drawn to scale and are merely used to illustrate the embodiments of the present invention. The terms such as "first" and "second" mentioned below do not represent any order, quantity, or importance, but are only used to distinguish different parts.

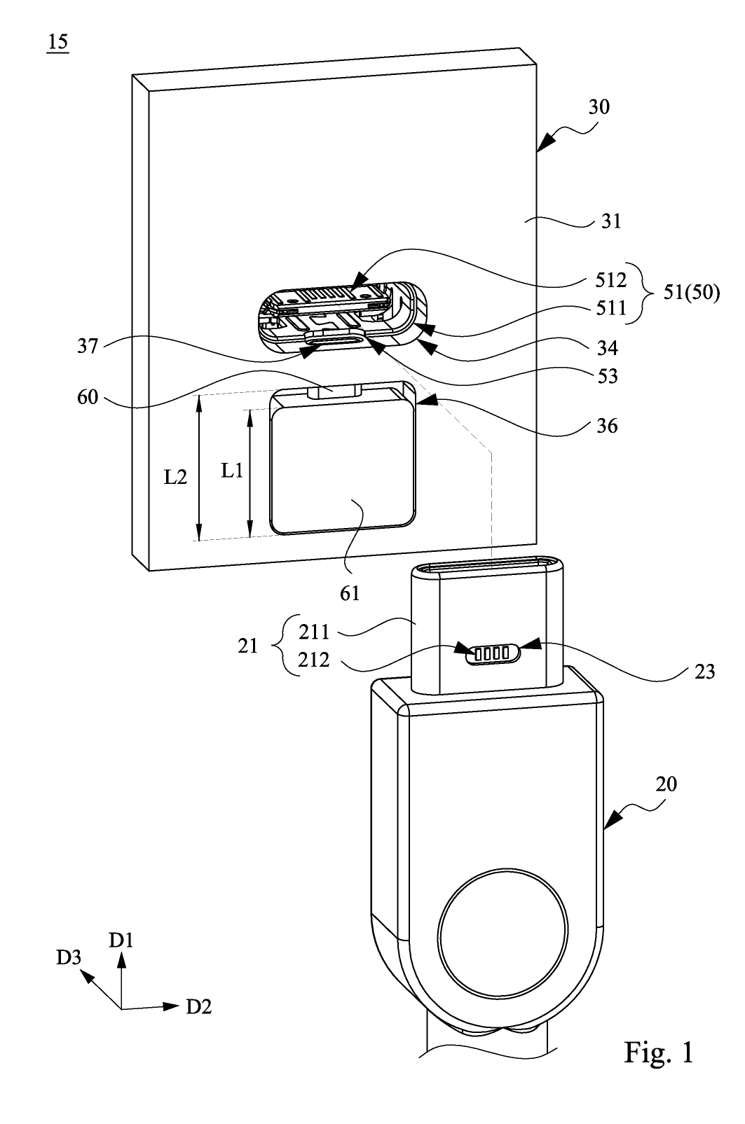

Please refer to FIG. 1, which is a schematic diagram of a connector system 15 according to an embodiment of the present disclosure. The connector system 15 includes a first electrical connector 20 and a connector device 30. The first electrical connector 20 includes a first connection portion 21. The first connection portion 21 includes a first shell 211 and a plurality of first terminals 212 disposed in the first shell 211. The first terminals 212 are made of a conductive material and are configured to transmit electric currents and/or signals. In this embodiment, the first electrical connector 20 is a USB Type-C male connector, but is not limited thereto. The first electrical connector 20 may also be a male connector of other specifications, such as USB Type-A, USB Type-B, etc.

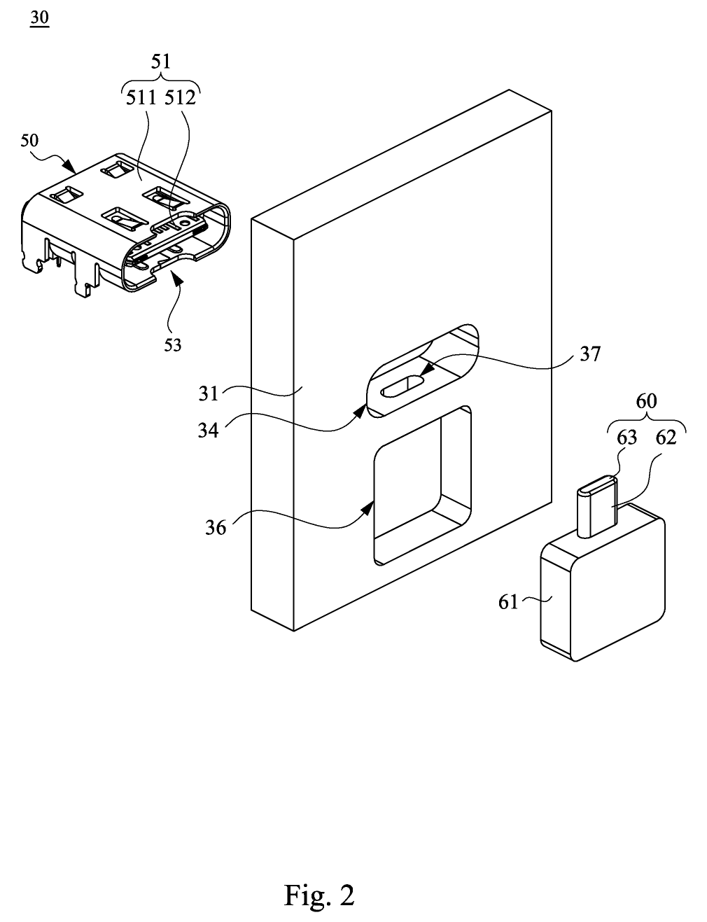

Please refer to FIGS. 1 and 2, the connector device 30 includes a housing 31, a second electrical connector 50, a latch 60, and a control element 61. The housing 31 is provided with a connection hole 34 penetrating through the housing 31. The second electrical connector 50 includes a second connection portion 51. The second connection portion 51 is disposed in at least a part of the connection hole 34, and includes a second shell 511 and a plurality of second terminals 512 disposed in the second shell 511. The second terminals 512 are made of a conductive material and are configured to transmit electric currents and/or signals. When the first connection portion 21 of the first electrical connector 20 is combined with the second connection portion 51 of the second electrical connector 50, the first terminals 212 of the first electrical connector 20 respectively contact the second terminals 512 of the second electrical connector 50 to achieve transmission of electric currents and/or signals between the first electrical connector 20 and the second electrical connector 50. In this embodiment, the second electrical connector 50 is a USB Type-C female connector, but is not limited thereto. The second electrical connector 50 may also be a female connector of other specifications, such as USB Type-A, USB Type-B, etc.

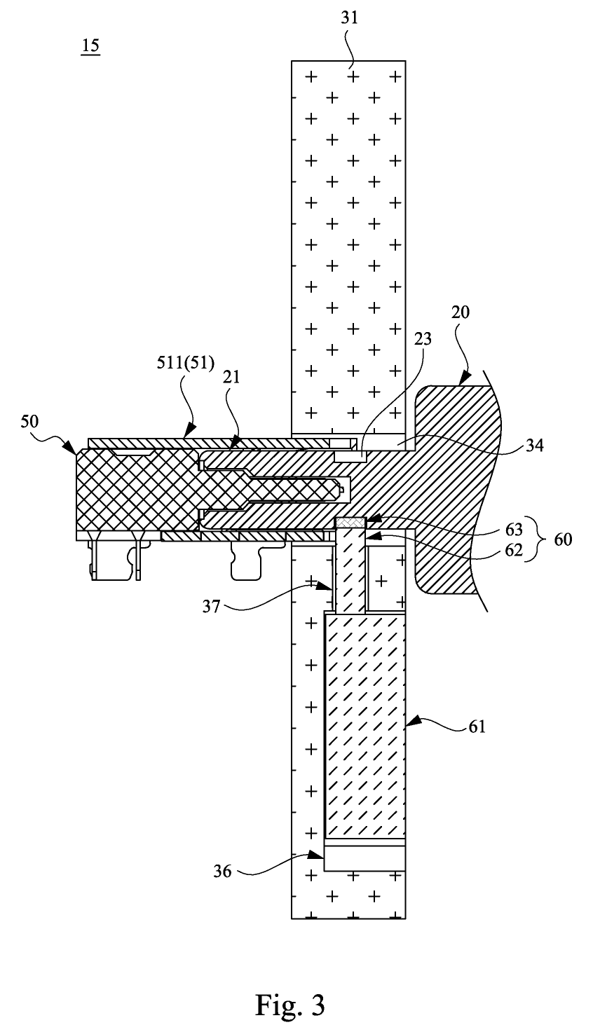

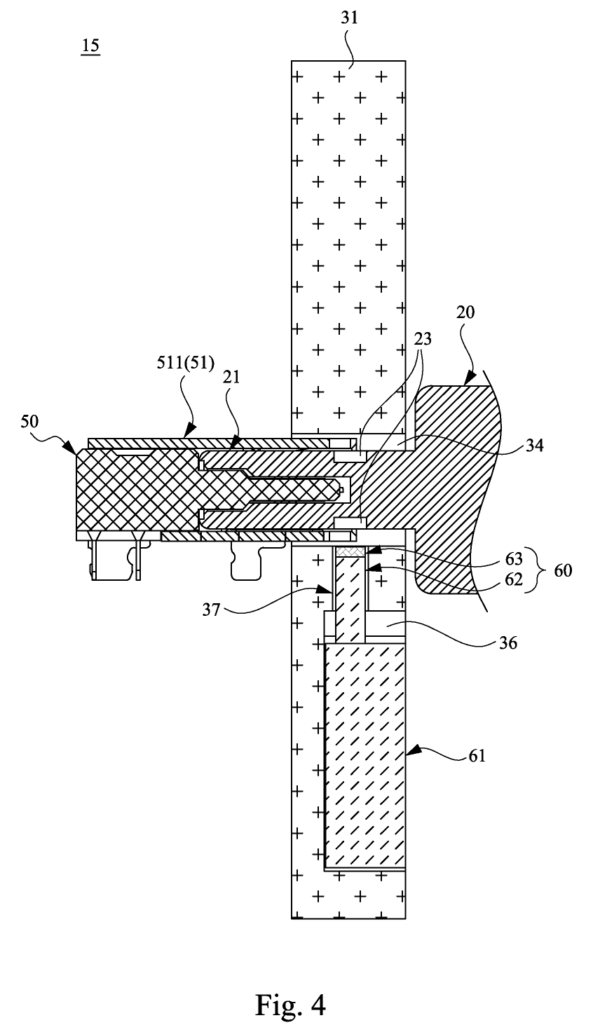

Please refer to FIG. 1, the latch 60 and the control element 61 are movably disposed on the housing 31. The control element 61 is configured to move the latch 60 to a first position as shown in FIG. 3, or a second position as shown in FIG. 4. Please refer to FIG. 3, when the latch 60 is at the first position, a part of the latch 60 is located in the connection hole 34 of the housing 31 and short-circuits at least two of the first terminals 212. Please refer to FIG. 4, when the latch 60 is at the second position, the part of the latch 60 is located outside the connection hole 34 of the housing 31.

Please refer to FIGS. 1 and 3, in an embodiment, the housing 31 is further provided with a recess 36 and a through hole 37. The through hole 37 communicates with the recess 36 and the connection hole 34. Specifically, the through hole 37 is located between the recess 36 and the connection hole 34, and penetrates through a sidewall between the recess 36 and the connection hole 34. The control element 61 is movably disposed in the recess 36. When the control element 61 moves the latch 60 to the first position, the part of the latch 60 enters the connection hole 34 through the through hole 37. When the control element 61 moves the latch 60 to the second position, the part of the latch 60 exits the connection hole 34. Please refer to FIG. 4, in this embodiment, when the latch 60 is at the second position, a top surface of the latch 60 is substantially flush with an inner surface of the connection hole 34, but is not limited thereto. In another embodiment, when the latch 60 is at the second position, the top surface of the latch 60 is inside the through hole 37 and is not flush with the inner surface of the connection hole 34.

Please refer to FIGS. 1 and 2, in an embodiment, the latch 60 is disposed on a surface of the control element 61 close to the through hole 37. Therefore, when the control element 61 moves within the recess 36, the latch 60 moves with the control element 61. Specifically, in a first direction D1, a length L1 of the recess 36 is greater than a length L2 of the control element 61, so that the control element 61 moves within the recess 36 along the first direction D1 or an opposite direction thereof, thereby causing the latch 60 to move within the through hole 37 along the first direction D1 or the opposite direction thereof. The first direction D1 is parallel to an extending direction of the through hole 37. In other words, a moving direction of the control element 61 is substantially parallel to the through hole 37, so that the latch 60 can move upward or downward within the through hole 37 along a direction parallel to the through hole 37. The moving direction of the control element 61 may also be substantially perpendicular to the first electrical connector 20 and the second electrical connector 50. In an embodiment, in a second direction D2, a width of the recess 36 may be substantially equal to a width of the control element 61, so that the control element 61 cannot move within the recess 36 along the second direction D2 or an opposite direction thereof. In other embodiments, two opposite sidewalls of the recess 36 parallel to the first direction D1 may each be provided with a slider, and two opposite side surfaces of the control element 61 may each be provided with a chute corresponding to the slider. The sliders slide within the chutes, which further limits the control element 61 to move within the recess 36 only along the first direction D1 or the opposite direction thereof, and cannot move along the second direction D2 or the opposite direction thereof, or a third direction D3 or an opposite direction thereof.

Please refer to FIGS. 1-4, in this embodiment, the second electrical connector 50 is located in a part of the connection hole 34. The second electrical connector 50 is provided with a notch 53 corresponding to a part of the through hole 37, such that the latch 60 can pass through the notch 53 and contact the first electrical connector 20 inserted into the second electrical connector 50. Specifically, the second connection portion 51 of the second electrical connector 50 is located in the part of the connection hole 34, and the second shell 511 of the second connection portion 51 is provided with the notch 53 corresponding to the part of the through hole 37 for the latch 60 to pass through.

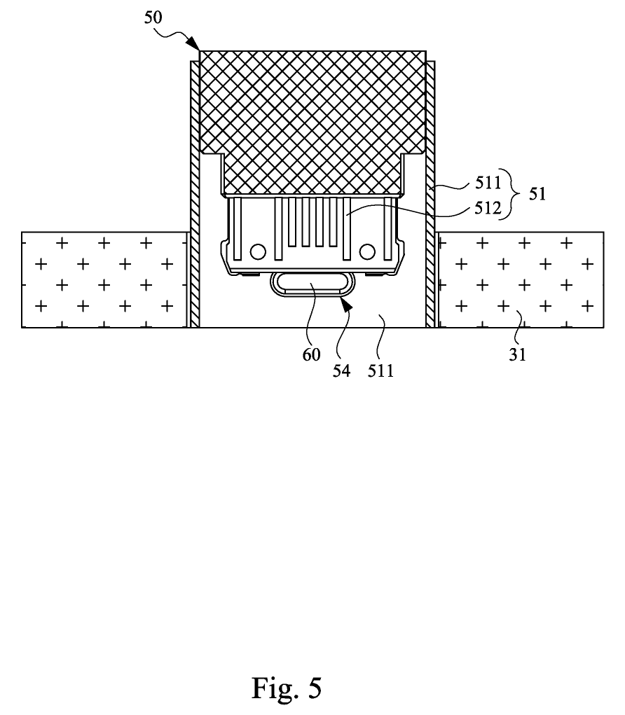

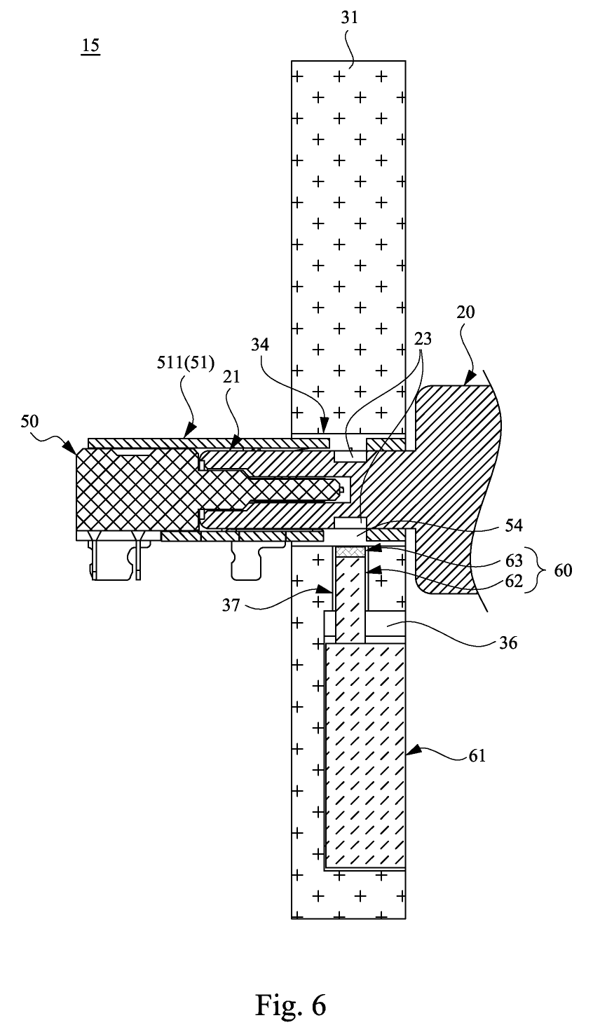

Please refer to FIGS. 5 and 6, in another embodiment, the second electrical connector 50 is located in the entire connection hole 34. The second electrical connector 50 is provided with a via hole 54 corresponding to the entire through hole 37 of the housing 31, such that the latch 60 can pass through the via hole 54 and contact the first electrical connector 20 inserted into the second electrical connector 50. Specifically, the second connection portion 51 of the second electrical connector 50 is located in the entire connection hole 34, and the second shell 511 of the second connection portion 51 is provided with the via hole 54 corresponding to the entire through hole 37 of the housing 31 for the latch 60 to pass through.

In the present disclosure, a thickness of the housing 31, a depth of the connection hole 34, and relative positions of the second electrical connector 50, the latch 60, and the connection hole 34 may be adjusted according to actual needs. It is only necessary to hollow out a portion of the second shell 511 of the second connection portion 51 of the second electrical connector 50 corresponding to the through hole 37 to allow the latch 60 to pass through.

Please refer to FIG. 1, in an embodiment, the first shell 211 of the first connection portion 21 of the first electrical connector 20 is provided with at least one opening 23. Each opening 23 exposes at least two of the first terminals 212. Specifically, each opening 23 exposes portions of the at least two of the first terminals 212. In an embodiment, the portions of the at least two of the first terminals 212 may protrude relative to other portions of the at least two of the first terminals 212 and be located in the opening 23. Please refer to FIG. 4, when the first electrical connector 20 is combined with the second electrical connector 50, the opening 23 of the first electrical connector 20 corresponds to the latch 60. In an embodiment, the first electrical connector 20 may be a reversible connector, and two opposite sides of the first shell 211 are each provided with the opening 23.

Please refer to FIGS. 1-3, in an embodiment, the latch 60 is made of a conductive material. When the first electrical connector 20 is combined with the second electrical connector 50, and the latch 60 is at the first position, the latch 60 is located within the opening 23 of the first electrical connector 20 and contacts the at least two of the first terminals 212 exposed by the opening 23, thereby short-circuiting the at least two of the first terminals 212. Please refer to FIG. 4, when the latch 60 is at the second position, the latch 60 is located outside the opening 23 of the first electrical connector 20 and is separated from the at least two of the first terminals 212. The control element 61 may be made of a non-conductive material. In an embodiment, the latch 60 may be adhered to the control element 61 or embedded in the control element 61 via insert molding. In other embodiments, the control element 61 may be made of a conductive material and may be integrally formed with the latch 60.

Please refer to FIG. 2, in another embodiment, the latch 60 includes a body 62 made of a non-conductive material and a conductive portion 63 disposed on a surface of the body 62 close to the connection hole 34. The conductive portion 63 may be a conductive block, a conductive film, or a conductive coating made of a conductive material, but is not limited thereto, as long as the conductive portion 63 has a conductive capability sufficient to short-circuit the at least two of the first terminals 212. The conductive block and the conductive film may be adhered to the body 62. The conductive block may also be embedded in the body 62 via insert molding. The conductive coating may be formed by coating the body 62 with a conductive material. Please refer to FIG. 3, when the first electrical connector 20 is combined with the second electrical connector 50, and the latch 60 is at the first position, the conductive portion 63 is located within the opening 23 of the first electrical connector 20 and contacts the at least two of the first terminals 212 exposed by the opening 23, thereby short-circuiting the at least two of the first terminals 212. Please refer to FIG. 4, when the latch 60 is at the second position, the conductive portion 63 is located outside the opening 23 of the first electrical connector 20 and is separated from the at least two of the first terminals 212. In an embodiment, the control element 61 may be made of a non-conductive material and may be integrally formed with the body 62 of the latch 60. In other embodiments, the control element 61 may be made of a conductive material.

Please refer to FIGS. 3 and 4, when the first electrical connector 20 and the second electrical connector 50 are combined, in a process of the latch 60 moving towards the first position, the latch 60 first enters the opening 23 of the first electrical connector 20, thereby preventing the first electrical connector 20 from being removed from the connection hole 34. Then, the latch 60 contacts the at least two of the first terminals 212 exposed by the opening 23, short-circuiting the at least two of the first terminals 212. In a process of the latch 60 moving towards the second position, the latch 60 first separates from the at least two of the first terminals 212, restoring the at least two of the first terminals 212 to a non-short-circuit state. Then, the latch 60 exits the opening 23 of the first electrical connector 20, thereby allowing the first electrical connector 20 to be removed from the connection hole 34.

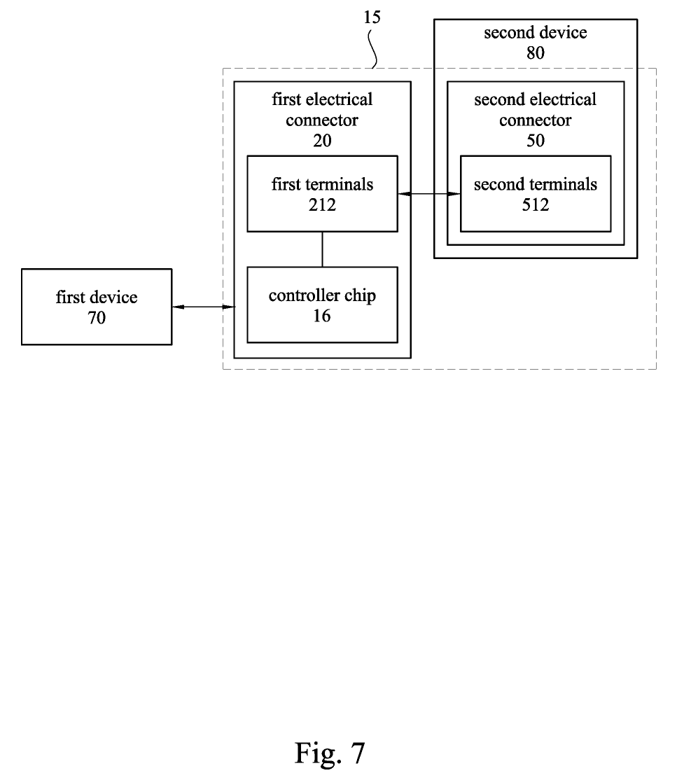

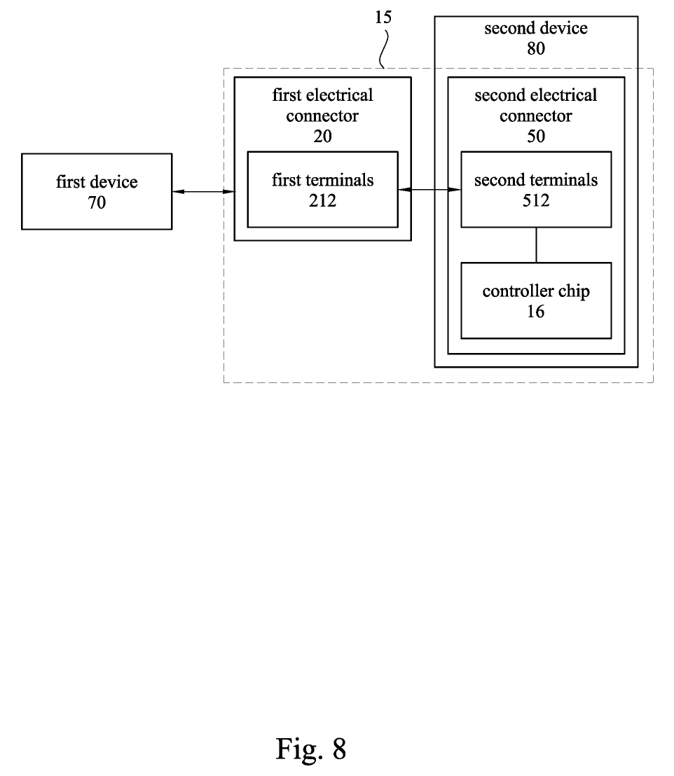

Please refer to FIGS. 7 and 8, which are schematic diagrams of applications of the connector system 15. For ease of illustration, some elements of the connector system 15 are omitted in FIGS. 7 and 8. In some embodiments, the connector system 15 further includes a control chip 16. Please refer to FIG. 7, in an embodiment, the control chip 16 is disposed in the first electrical connector 20 and is electrically connected to the at least two of the first terminals 212. The control chip 16 is configured to detect whether the at least two of the first terminals 212 are short-circuited, and to execute an action when the control chip 16 detects that the at least two of the first terminals 212 are short-circuited. Please refer to FIG. 8, in another embodiment, the control chip 16 is disposed in the second electrical connector 50 and is electrically connected to at least two of the second terminals 512 corresponding to the at least two of the first terminals 212. The at least two of the second terminals 512 contact the at least two of the first terminals 212, respectively. The control chip 16 is electrically connected to the at least two of the first terminals 212 via the at least two of the second terminals 512 and is configured to detect whether the at least two of the first terminals 212 are short-circuited. When the control chip 16 detects that the at least two of the first terminals 212 are short-circuited, the control chip 16 executes an action.

Specifically, please refer to FIGS. 1, 3, 4, 7, and 8, when the first electrical connector 20 is combined with the second electrical connector 50, and the control element 61 moves the latch 60 to the first position, the latch 60 short-circuits the at least two of the first terminals 212 of the first electrical connector 20. At this time, the control chip 16 detects that the at least two of the first terminals 212 are short-circuited, and thus executes a first action. When the control element 61 moves the latch 60 to the second position, the at least two of the first terminals 212 of the first electrical connector 20 return to the non-short-circuit state. At this time, the control chip 16 detects that the at least two of the first terminals 212 are not short-circuited, and thus executes a second action. The second action is different from the first action. The second action may be to stop executing the first action.

Please refer to FIGS. 1, 7, and 8, in an embodiment, the first electrical connector 20 may be electrically connected to a first device 70 via a cable. Specifically, the first electrical connector 20 is disposed at an end of the cable, and the other end of the cable is electrically connected to the first device 70. The second electrical connector 50 may be disposed on a second device 80. Specifically, the connector device 30 is a part of the second device 80, the housing 31 is a housing of the second device 80, and the second electrical connector 50 is embedded in the housing of the second device 80. When the first connection portion 21 of the first electrical connector 20 is inserted into the second connection portion 51 of the second electrical connector 50, the first terminals 212 contact the second terminals 512, so that the first electrical connector 20 is electrically connected to the second electrical connector 50, thereby achieving transmission of electric currents and/or signals between the first device 70 and the second device 80. In other embodiments, the first electrical connector 20 may be disposed on the first device 70, and the second electrical connector 50 may be electrically connected to the second device 80 via a cable.

Please refer to FIGS. 7 and 8, in an embodiment, the first device 70 is an electronic device, and the second device 80 is a power supply device. When a user moves the latch 60 to the first position through the control element 61 to short-circuit the at least two of the first terminals 212, the first action executed by the controller chip 16 after detecting the short-circuit is to instruct the second device 80 to provide power with a first voltage to the first device 70. When the user moves the latch 60 to the second position through the control element 61 to return the at least two of the first terminals 212 to the non-short-circuit state, the second action executed by the controller chip 16 after detecting the non-short-circuit state is to instruct the second device 80 to provide power with a second voltage to the first device 70. The first voltage is greater than the second voltage. For example, when the second electrical connector 50 of the second device 80 is a USB Type-C connector with Extended Power Range (EPR), the first voltage may be 48V, 36V, or 28V, and the second voltage may be 20V, 15V, 9V, or 5V. In other embodiments, the second voltage may also be 0V, indicating that the second device 80 does not provide power.

In the aforementioned embodiment, when the user wants the second device 80 to provide the power with the first voltage (i.e., a higher voltage) to the first device 70, the user must first move the latch 60 to the first position. During movement of the latch 60 from the second position to the first position, the latch 60 first enters the opening 23 of the first electrical connector 20 to lock the first electrical connector 20 to the connector device 30, and then the latch 60 contacts the at least two of the first terminals 212 to short-circuit the at least two of the first terminals 212. The at least two of the first terminals 212 are not used for charging. Then, the control chip 16 detects that the at least two of the first terminals 212 are short-circuited, and thus executes the first action, causing the second device 80 to provide the power with the first voltage to the first device 70. This ensures that the first electrical connector 20 will not be detached from the connector device 30 when the second device 80 provides the power with the higher voltage. If the first electrical connector 20 is detached from the connector device 30 due to external force or gravity when the second device 80 provides the power with the higher voltage, an electric arc may be generated between the first electrical connector 20 and the second electrical connector 50, and the electric arc may damage the first electrical connector 20 and the second electrical connector 50.

Furthermore, when the user wants to remove the first electrical connector 20 from the connector device 30, the user must first move the latch 60 to the second position. During movement of the latch 60 from the first position to the second position, the latch 60 first separates from the at least two of the first terminals 212, so that the at least two of the first terminals 212 return to the non-short-circuit state. The control chip 16 detects the non-short-circuit state, and thus executes the second action, causing the second device 80 to provide the power with the second voltage to the first device 70. That is, the second device 80 provides power with a lower voltage, or stops providing power). Then, the latch 60 exits the opening 23 of the first electrical connector 20, allowing the first electrical connector 20 to be removed from the connector device 30. A time difference between separation of the latch 60 from the at least two of the first terminals 212 and removal of the first electrical connector 20 from the connector device 30 is at least 30 milliseconds. Therefore, before the first electrical connector 20 is removed from the connector device 30, the second device 80 has switched to provide the power with the second voltage (i.e., provides the power with the lower voltage, or stops providing power). This effectively prevents arcing between the first electrical connector 20 and the second electrical connector 50 when the first electrical connector 20 is removed from the connector device 30.

In another embodiment, the first device 70 may be a power supply device, and the second device 80 may be an electronic device. The first action is to instruct the first device 70 to provide power with the first voltage to the second device 80. The second action is to instruct the first device 70 to provide power with the second voltage to the second device 80.

In other embodiments, the first device 70 and the second device 80 may be electronic devices. The first action may be to instruct the first device bto transmit data to the second device 80 at a first speed. The second action may be to instruct the first device 70 to transmit data to the second device 80 at a second speed. The first speed is greater than the second speed.

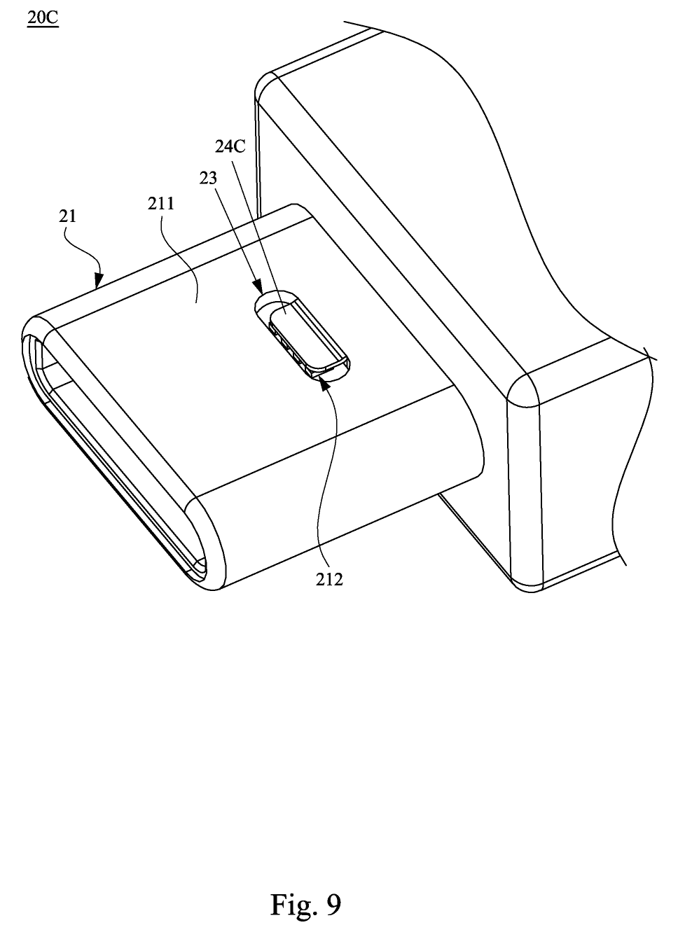

Please refer to FIG. 9, which is a partially enlarged view of a first electrical connector 20C according to another embodiment of the present disclosure. A first shell 211 of a first connection portion 21 of the first electrical connector 20C is made of a conductive material and includes a spring sheet 24C corresponding to at least two first terminals 212. In this embodiment, the spring sheet 24C may extend from an edge of an opening 23 and cover a part of the opening 23. In other embodiments, the spring sheet 24C may also be formed by cutting a U-shaped slit in the first shell 211. Please refer to FIGS. 1, 3, 4, and 9, when the first electrical connector 20C is combined with the second electrical connector 50, the latch 60 corresponds to the spring sheet 24C. When the latch 60 is at the first position, the latch 60 presses the spring sheet 24C, causing the spring sheet 24C to contact the at least two first terminals 212 and short-circuit the at least two first terminals 212. When the latch 60 is at the second position, the spring sheet 24C returns to its original position due to its own elasticity, and thus moves away from the at least two first terminals 212, so that the at least two first terminals 212 return to a non-short-circuit state. In this embodiment, the latch 60 and the control element 61 may be integrally formed of a non-conductive material to save manufacturing time and cost, but the present invention is not limited thereto.

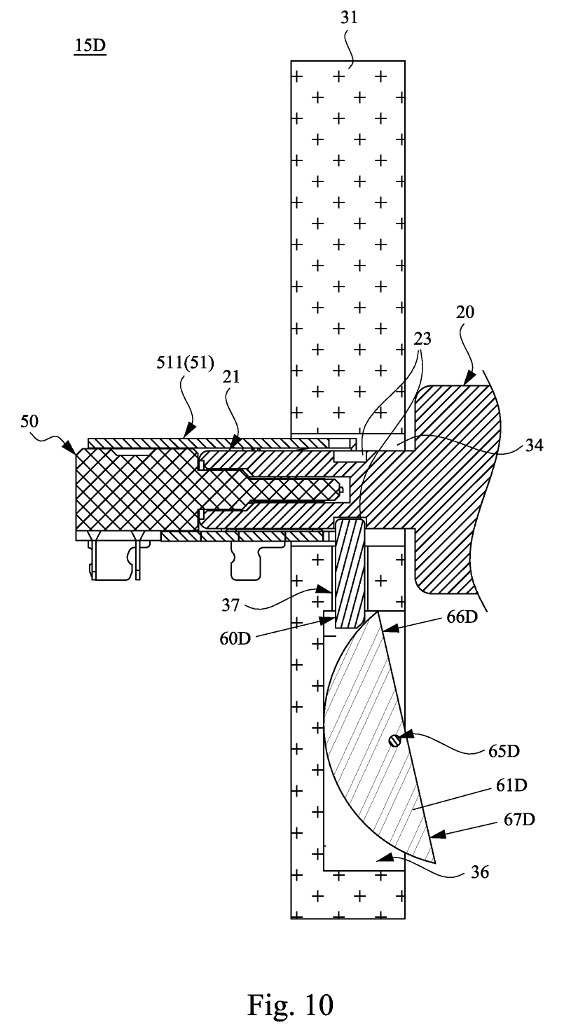

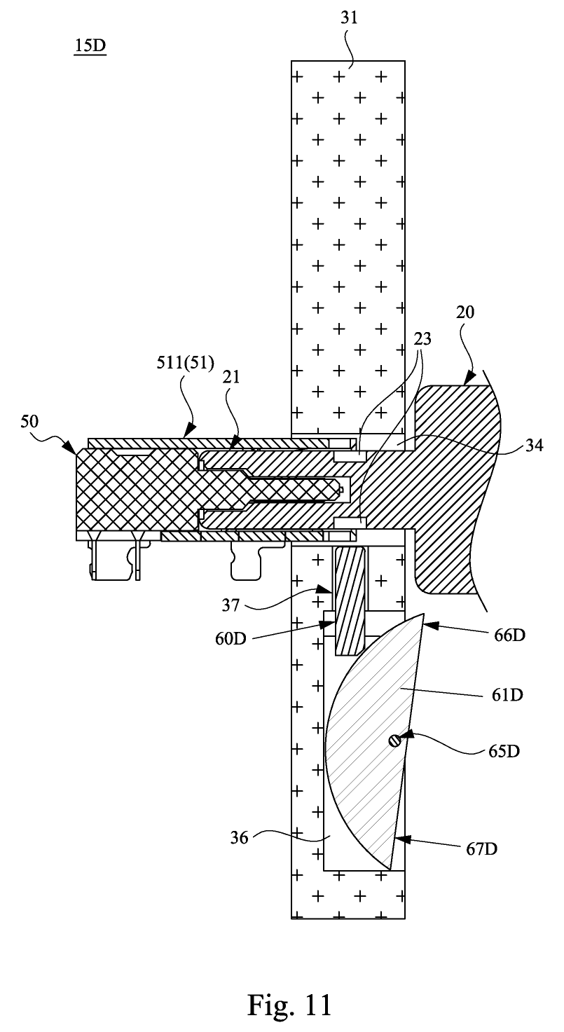

Please refer to FIGS. 10 and 11, which are cross-sectional views of a connector system 15D in different states according to another embodiment of the present disclosure. In this embodiment, a latch 60D is movably disposed in the through hole 37, and a control element 61D is rotatably disposed in the recess 36 via a pivot 65D and contacts the latch 60D. The control element 61D includes a first operation portion 66D and a second operation portion 67D. The first operation portion 66D and the second operation portion 67D are located at two opposite ends of the control element 61D. Please refer to FIG. 10, when the user presses the first operation portion 66D, the control element 61D rotates counterclockwise and pushes the latch 60D to the first position. Please refer to FIG. 11, when the user presses the second operation portion 67D, the control element 61D rotates clockwise, and the latch 60D moves down to the second position. In this embodiment, the latch 60D may be made of a conductive material. In other embodiments, the latch 60D may also be the latch 60 including the conductive portion 63 and the body 62, as shown in FIG. 4. In addition, the control element 61D may be made of a non-conductive material, but is not limited thereto. In the present disclosure, the control element and the latch are not limited to the designs shown in FIGS. 4 and 11, as long as the user can move the latch to the first position and the second position through the control element.

The embodiments are described in detail above, so that those skilled in the art can fully understand the concept of the present invention. Based on the embodiments, all other embodiments obtained by those skilled in the art without any creative labor shall fall within the scope of the present invention. That is, those skilled in the art may modify the technical solutions in the embodiments, or replace one or more technical features in the embodiments with equivalents. These modifications or equivalent replacements shall fall within the scope of the present invention. Therefore, the scope of the present invention is determined by the appended claims.

What is claimed is:

1. A connector device, comprising:
a housing provided with a connection hole;
an electrical connector disposed in at least a part of the connection hole;
a latch movably disposed on the housing; and
a control element movably disposed on the housing and configured to move the latch to a first position or a second position, wherein a part of the latch is located in the connection hole when the latch is at the first position, and the part of the latch is located outside the connection hole when the latch is at the second position.

2. The connector device of claim 1, wherein the housing is further provided with a recess and a through hole, the through hole communicates with the recess and the connection hole, the control element is movably disposed in the recess, the part of the latch enters the connection hole through the through hole when the control element moves the latch to the first position, and the part of the latch exits the connection hole when the control element moves the latch to the second position.

3. The connector device of claim 2, wherein the latch is disposed on a surface of the control element close to the through hole, and a moving direction of the control element is substantially parallel to the through hole.

4. The connector device of claim 3, wherein the moving direction of the control element is substantially perpendicular to the electrical connector.

5. The connector device of claim 2, wherein the latch is movably disposed in the through hole, and the control element is rotatably disposed in the recess and contacts the latch.

6. The connector device of claim 2, wherein the electrical connector is provided with a notch corresponding to a part of the through hole of the housing, or a via hole corresponding to an entirety of the through hole of the housing.

7. The connector device of claim 1, wherein the latch is made of a conductive material.

8. The connector device of claim 1, wherein the latch comprises a body made of a non-conductive material and a conductive portion disposed on a surface of the body close to the connection hole.

9. A connector system, comprising:
a first electrical connector comprising a first connection portion, wherein the first connection portion comprises a first shell and a plurality of first terminals disposed in the first shell; and
a connector device comprising:
a housing provided with a connection hole;
a second electrical connector comprising a second connection portion, wherein the second connection portion is disposed in at least a part of the connection hole and comprises a second shell and a plurality of second terminals disposed in the second shell, and the first terminals contact the second terminals when the first connection portion is combined with the second connection portion;
a latch movably disposed on the housing; and
a control element configured to move the latch to a first position or a second position, wherein a part of the latch is located in the connection hole and short-circuits at least two of the first terminals when the latch is at the first position, and the part of the latch is located outside the connection hole when the latch is at the second position.

10. The connector system of claim 9, wherein the housing is further provided with a recess and a through hole, the through hole communicates with the recess and the connection hole, the control element is movably disposed in the recess, the part of the latch enters the connection hole through the through hole when the control element moves the latch to the first position, and the part of the latch exits the connection hole when the control element moves the latch to the second position.

11. The connector system of claim 10, wherein the latch is disposed on a surface of the control element close to the through hole, and a moving direction of the control element is substantially parallel to the through hole.

12. The connector system of claim 10, wherein the latch is movably disposed in the through hole, and the control element is rotatably disposed in the recess and contacts the latch.

13. The connector system of claim 10, wherein the second electrical connector is provided with a notch corresponding to a part of the through hole of the housing, or a via hole corresponding to an entirety of the through hole of the housing.

14. The connector system of claim 9, further comprising a controller chip, wherein the control chip is disposed in the first electrical connector and electrically connected to the at least two of the first terminals, or is disposed in the second electrical connector and electrically connected to the second terminals corresponding to the at least two of the first terminals, and the control chip is configured to detect whether the at least two of the first terminals are short-circuited, and to execute an action when the control chip detects that the at least two of the first terminals are short-circuited.

15. The connector system of claim 9, wherein the first shell is provided with an opening, the opening exposes the at least two of the first terminals, the latch is made of a conductive material, and when the latch is at the first position, the latch contacts the at least two of the first terminals.

16. The connector system of claim 9, wherein the first shell is provided with an opening, the opening exposes the at least two of the first terminals, the latch comprises a body made of a non-conductive material and a conductive portion disposed on a surface of the body close to the connection hole, and when the latch is at the first position, the conductive portion contacts the at least two of the first terminals.

17. The connector system of claim 9, wherein the first shell is made of a conductive material and comprises a spring sheet corresponding to the at least two of the first terminals, the latch corresponds to the spring sheet, and when the latch is at the first position, the latch makes the spring sheet contact the at least two of the first terminals.
